(19) United States
(12) Patent Application Publication
(10) Pub. No.: US 2007/0223848 A1
(43) Pub. Date: Sep. 27, 2007

(54) Fluid dynamic bearing system

(76) Inventor: Olaf Winterhalter, Epfendorf (DE)

Correspondence Address: COOPER & DUNHAM, LLP, 1185 AVENUE OF THE AMERICAS, NEW YORK, NY, 10036, US

(21) Appl. No.: 11/726,619

(22) Filed: Mar. 22, 2007

(30) Foreign Application Priority Data
Mar. 24, 2006 (DE) 10 2006 013 536.9

(51) Int. Cl. F16C 32/06

(52) U.S. Cl. 384/100

(57) ABSTRACT

The invention relates to a fluid dynamic bearing system particularly for a spindle motor having a rotating component comprising a shaft and a hub connected to the shaft, and a stationary component comprising a bearing bush made of a porous material, the shaft being accommodated in the bearing bush and rotatably supported with respect to the bearing bush, and there being a bearing gap filled with a bearing fluid between the shaft and the bearing bush. According to the invention, the bearing bush is at least partly enclosed by a sleeve, a surface of the sleeve together with an adjoining surface of the rotating component forming a conical seal.

### BACKGROUND OF THE INVENTION

The invention relates to a fluid dynamic bearing system used particularly to rotatably support a spindle motor as employed, for example, for driving hard disk drives.

### PRIOR ART

Spindle motors substantially consist of a stator, a rotor and at least one bearing system arranged between these two parts. The electrically driven rotor is rotatably supported with respect to the stator by means of the bearing system. Fluid dynamic bearings are frequently employed as the bearing system.

DE 202 18 821 U1 reveals a typical fluid dynamic bearing system for spindle motors that comprises a bearing bush and a shaft which is disposed in an axial bore in the bearing bush. The shaft rotates freely in the bearing bush, the two parts together forming a radial bearing whose surfaces are spaced apart from each other by a thin, concentric bearing gap filled with a lubricant.

Axial displacement of the shaft along the rotational axis is prevented by appropriately designed fluid dynamic thrust bearings. These kinds of thrust bearings are frequently formed by the two end faces of a thrust plate arranged at one end of the shaft, each end face being associated with a corresponding end face of the bearing bush and an inner end face of a cover plate. The cover plate forms a counter bearing to the thrust plate and seals the entire bearing system from below.

The components of the bearing system are generally made of steel, aluminum or sintered materials and are connected to each other by pressing, welding or bonding.

The use of sintered materials is a low-cost alternative to turned and machined components. Components having the simplest possible geometric shapes are to be preferred in the sinter process.

If the bearing components are made of sintered materials, i.e. porous materials, the problem arises of their being saturated with the bearing fluid used, preferably bearing oil, thus allowing the bearing fluid to permeate through the bearing components, particularly the bearing bush, and to leak out of the bearing.

### SUMMARY OF THE INVENTION

It is the object of the invention to provide a fluid dynamic bearing system that comprises bearing components made of porous materials and that is suitable for use in a spindle motor, wherein the escape of bearing oil, particularly from those regions of the bearing components made of porous material, is to be prevented.

This object has been achieved according to the invention by the characteristics revealed in claim 1. A preferred example of the embodiments of the invention and other advantageous characteristics can be derived from the subordinate claims.

The depicted fluid dynamic bearing system is particularly intended for use in a spindle motor and includes a rotating component comprising a shaft and a hub connected to the shaft, and a stationary component comprising a bearing bush made of a porous material. The shaft is accommodated in a bore of the bearing bush and supported rotatably with respect to the bearing bush. There is a bearing gap filled with bearing fluid between the shaft and the bearing bush. According to the invention, the bearing bush is at least partly enclosed by a sleeve, a surface of the sleeve together with an adjoining surface of the rotating component, i.e. a corresponding surface of the hub and/or of the shaft, forming a conical seal.

In one possible embodiment of the invention, the conical seal is formed by a circumferential surface of the sleeve and an adjoining surface disposed at an inside circumference of the hub.

In another embodiment of the invention, the conical seal is formed by an end face of the sleeve, an end face of the bearing bush and an adjoining surface disposed on a T-shaped section of the shaft.

On the one hand, the sleeve seals the preferably sintered bearing bush against penetrating bearing fluid and, on the other hand, forms a conical seal together with the hub for the purpose of sealing the bearing gap. The conical seal consists of a seal gap connected to the bearing gap, the seal gap being partly filled with bearing fluid and narrowing in the direction of the bearing gap. Here, the seal gap may either extend mainly parallel or mainly perpendicular to the bearing gap.

In a preferred embodiment of the invention, the sleeve has at least one open end that has a rim. The conical shape of the seal gap is realized in that the sleeve has a first outside diameter that continuously increases in the region of the rim up to a second outside diameter.

The other end of the sleeve is preferably sealed by a bottom piece, thus preventing bearing fluid from leaking out in this region. The open end of the bearing system is sealed by the described conical seal.

Since the bearing bush is made of a porous material, preferably a sintered material, it can be manufactured at relatively low cost. The sleeve or mounting sleeve respectively, is preferably made of plastics and can likewise be manufactured at low cost. However, it is also possible for the sleeve to be made only partly of plastics. Here the sleeve is preferably made of plastics in the region of the rim that forms part of the conical seal, whereas the remaining part of the sleeve may be made, for example, of metal. This embodiment also makes it possible for the sleeve to be constructed in two parts.

### BRIEF DESCRIPTION OF THE DRAWINGS

FIG. 1 shows a first embodiment of the fluid dynamic bearing according to the invention.

FIG. 2 shows a second embodiment of the fluid dynamic bearing according to the invention.

FIG. 3 shows a third embodiment of the fluid dynamic bearing according to the invention.

FIG. 4 shows a fourth embodiment of the fluid dynamic bearing according to the invention.

FIG. 5 shows a fifth embodiment of the fluid dynamic bearing according to the invention.

### DESCRIPTION OF PREFERRED EMBODIMENTS OF THE INVENTION

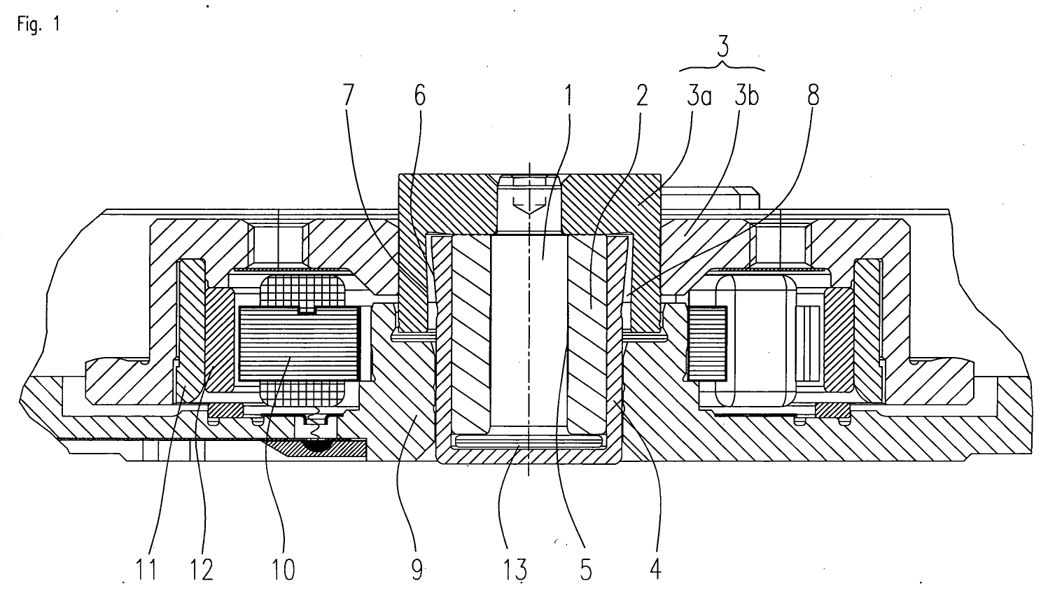

The spindle motor according to FIG. 1, which can be used, for example, for driving a hard disk drive, comprises a stationary baseplate 9 on which a stator arrangement 10, consisting of a stator core and windings is disposed. A shaft 1 is rotatably accommodated in an axial, cylindrical bore in a bearing bush 2.

The bearing bush 2 is directly or indirectly connected to the baseplate 9. The free end of the shaft 1 carries a hub 3 made up of one or of several parts 3a, 3b, which can, for example, be given a bell-shape and on which one or more storage disks (not illustrated) of the hard disk drive can be disposed and fixed. An annual permanent magnet 12 enclosed by a yoke 11 and having a plurality of pole pairs is disposed at the lower inside edge of the hub 3, an alternating electric field being applied to the pole pairs via a stator arrangement 10 spaced apart from them by means of an air gap, so that the hub 3 together with the shaft 1 is put into rotation. The shaft 1, together with the bearing bush 2 and a thrust plate 13 disposed at one end of the shaft 1, forms a fluid dynamic bearing system having radial bearing and axial bearing surfaces that are separated from each other by a bearing gap 5. The bearing gap 5 is filled with a bearing fluid, such as bearing oil. The construction and function of this kind of fluid dynamic bearing system is known to a person skilled in the art and shall not be described in more detail here. The bearing arrangement is sealed from below, i.e. in the region of the thrust plate 13, by appropriate means, thus preventing bearing fluid from leaking out in this region.

The bearing bush 2 is preferably made of sintered material and is correspondingly porous making it possible for bearing fluid to permeate from the bearing gap 5 through the bearing bush 2 to the outside.

According to the invention, this is prevented in that the greatest part of the bearing bush 2 is enclosed by a sleeve 4 that is closed at one end and seals the bearing system from below in the region of the thrust plate 13. The thrust plate 13 is thus rotatably disposed in a space between the end face of the bearing bush 2 and the bottom of the sleeve 4, and forms an axial bearing with the end face of the bearing bush 2. The sleeve 4 is open at its upper end. The end face of the bearing bush 2 facing the hub 3, or the hub part 3a respectively, forms a second axial bearing together with the adjoining axial end face of the hub part 3a, this axial bearing extending the bearing gap 5 in a radial direction to over the end face of the sleeve 4. The outside circumference 6 of the open rim of the sleeve 4 together with an opposing inside circumference 7 of the hub part 3a forms a conical seal that comprises a seal gap 8 which is connected to the bearing gap and partly filled with bearing fluid. The seal gap 8 narrows conically in the direction of the bearing gap, which results in the outside diameter of the sleeve 4 continuously increasing in the direction of its end face. In the preferred embodiment of the invention, the sleeve 4 is made entirely of plastics, encloses the bearing system and is held in a recess in the baseplate.

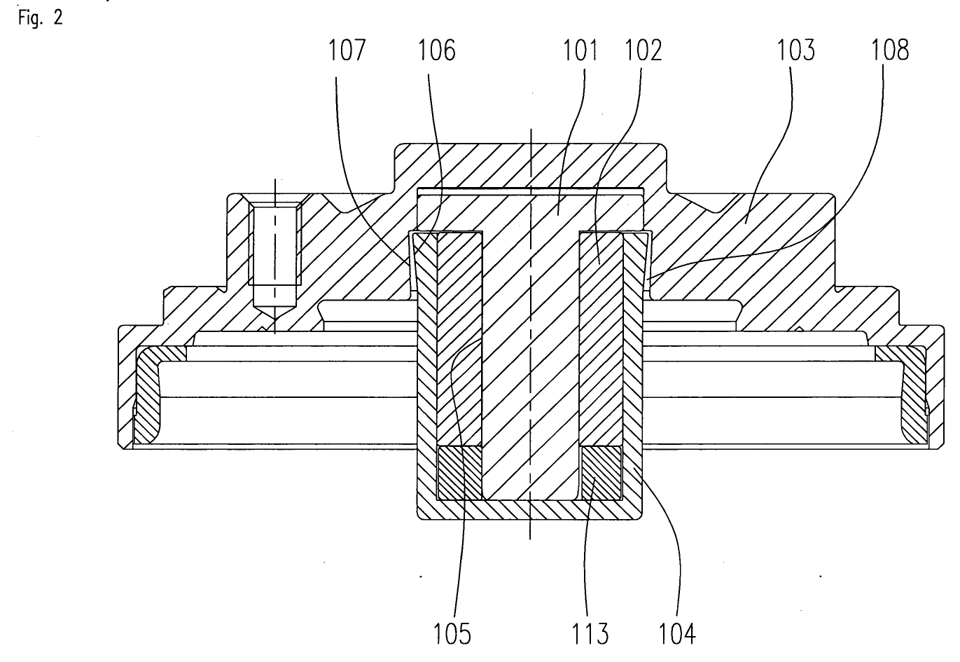

FIG. 2 shows another embodiment of the invention in which at one end of the shaft 101 there is a T-shaped widening on which the hub 103 is fixed. This. T-shaped widening makes it possible to realize a more robust and more precisely aligned connection between the shaft 101 and hub 103. The shaft 101 is accommodated in a bore in a preferably sintered bearing bush 102 and carries a thrust plate 113 at its other end. The greatest part of this bearing arrangement is enclosed by a cup-shaped sleeve 104 that seals the bearing system in the region of the thrust plate 113. The bearing gap 105 extends between the surfaces adjoining each other of the shaft 101, the bearing bush 102 and the thrust plate 113. A first axial bearing is formed between the surfaces adjoining each other of the thrust plate 113 and the bearing bush 102. A second axial bearing is formed between the surfaces adjoining each other of the bearing bush 102 and the T-shaped section of the shaft 101. The bearing gap 105 continues in a seal gap 108 that is formed between the outside circumference 106 of the sleeve 104 at the rim and an inside circumference 107 of the hub 103. This seal gap 108 is partly filled with bearing fluid and forms a conical seal to seal the bearing gap 105. Neither the baseplate nor the electromagnetic drive system of the spindle motor are illustrated in this figure but accord with the components shown in FIG. 1.

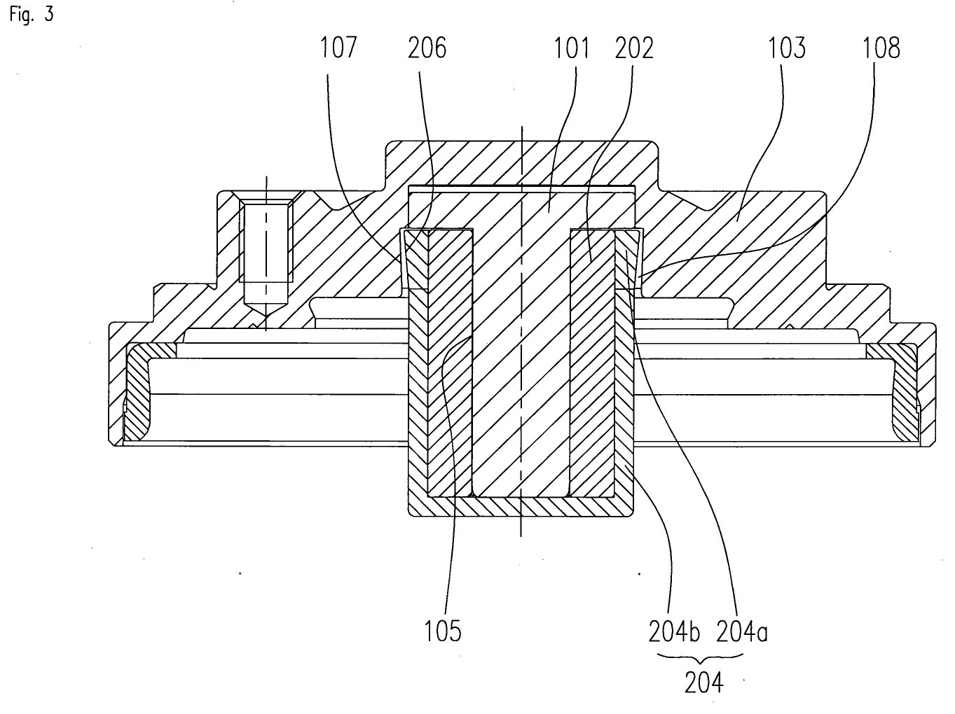

FIG. 3 shows a further embodiment of the invention having a two-piece sleeve 204 consisting of a cup-shaped lower part 204b and a slanted upper annular part 204a. The two-piece sleeve 204 encloses a sintered bearing bush 202 in which a T-shaped shaft 101, for example, is rotatably supported. The hub 103 is seated on the shaft 101. In this embodiment, only the part 204a of the sleeve 204 at the rim is preferably made of plastics and injection-molded onto the lower part 204b of the sleeve, or the outside circumference of the bearing bush 202 respectively. The outside diameter 206 of the upper part 204a of the sleeve made of plastics together with an inside diameter 107 of the hub 103 forms a conical seal having a corresponding seal gap 108 that seals the bearing gap 105 towards the outside. The can-shaped sleeve part 204b can either be made of plastics or of metal, as a molded part for example.

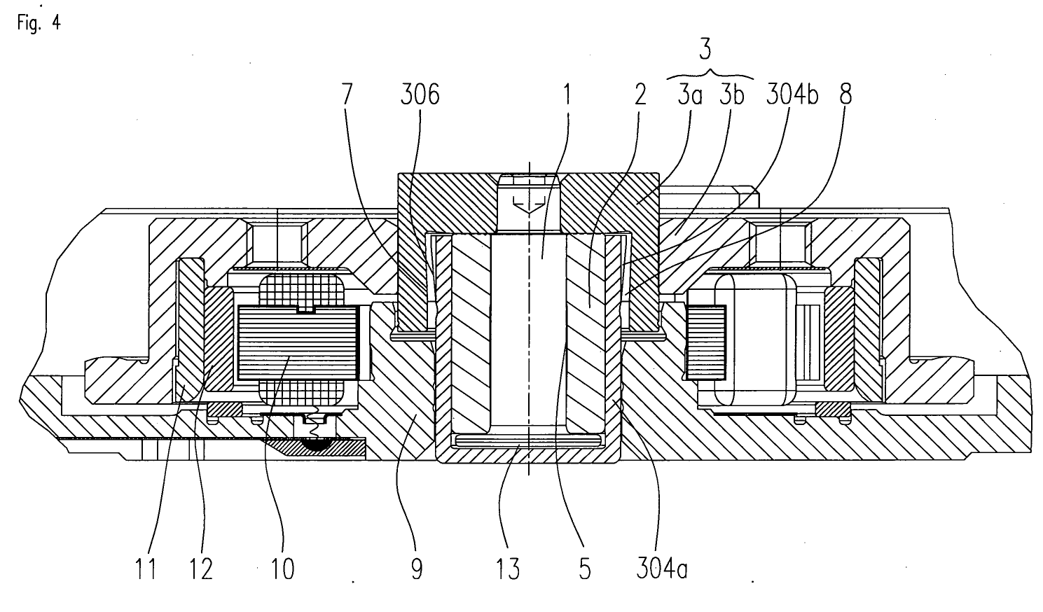

The spindle motor shown in FIG. 4 corresponds in its construction to the spindle motor according to FIG. 1, the same components being indicated by the same reference numbers.

The bearing bush 2 is enclosed by a sleeve 304 that is closed at one end and seals the bearing system from below in the region of the thrust plate 13. The sleeve 304 is open at its upper end. The sleeve 304 consists, for example, of a metallic can 304a on whose upper rim a torus 304b made of plastics is injection-molded. The outside circumference 306 of the torus 304b together with an opposing inside circumference 7 of the hub part 3a forms a conical seal that comprises a seal gap 8 which is connected to the bearing gap and is partly filled with bearing fluid. The seal gap 8 narrows conically in the direction of the bearing gap, which results in the outside diameter of the torus 304b continuously increasing in the direction of the open end of the sleeve.

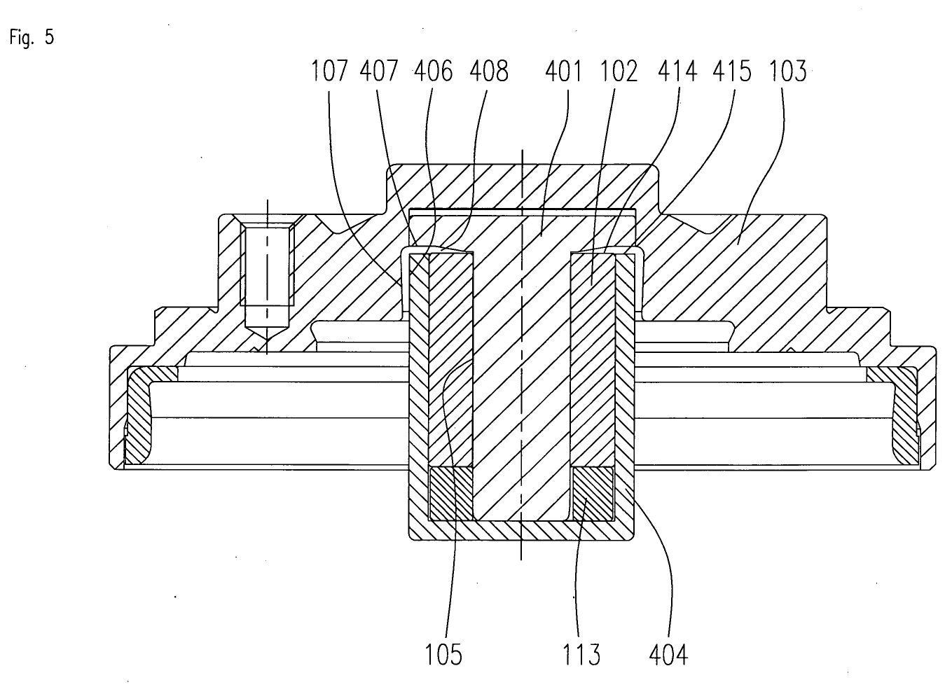

FIG. 5 shows a similar embodiment of the invention as in FIG. 2, where on one end of the shaft 401 there is a T-shaped widening on which the hub 103 is fixed. This T-shaped widening makes it possible to realize a more robust and more precisely aligned connection between the shaft 401 and hub 103. The shaft 401 is accommodated in a bore in a preferably sintered bearing bush 102 and carries a thrust plate 113 at its other end. The greatest part of this bearing arrangement is enclosed by a cup-shaped sleeve 404 that seals the bearing system in the region of the thrust plate 113. The bearing gap 105 extends between the surfaces adjoining each other of the shaft 401, the bearing bush 102 and the thrust plate 113. The bearing gap 105 continues in a seal gap 408 that is formed between the two end faces 414, 415 of the bearing bush 102 and of the sleeve 404 and an adjoining radially extending surface 407 of the shaft 401. The surface 407 of the shaft 401 is slanted so that the seal gap 408 widens outwards from the bearing gap 105 and forms a conical seal to seal the bearing gap 105.

As a whole, the bearing system according to the invention can be constructed at relatively low cost, owing to the sintered bearing bush on the one hand and on the other hand due to the sleeve made of plastics or of a combination of a plastic part and a low-cost sheet metal part.

Since the sleeve encloses a large part of the bearing system, it further provides the bearing system with a seal towards the outside.

### IDENTIFICATION REFERENCE LIST

1 Shaft
2 Bearing bush
3 Hub (3a, 3b)
4 Sleeve
5 Bearing gap
6 Circumferential surface (sleeve)
7 Surface (hub)
8 Seal gap
9 Baseplate
10 Stator arrangement
11 Yoke
12 Permanent magnet
13 Thrust plate
101 Shaft
102 Bearing bush
103 Hub
104 Sleeve
105 Bearing gap
106 Circumferential surface (sleeve)
107 Surface (hub)
108 Sealgap
113 Thrust plate
202 Bearing bush
204 Sleeve (204a, 204b)
206 Circumferential surface (sleeve part 204a)
304 Sleeve (304a, 304b)
306 Circumferential surface (sleeve part 304b)
401 Shaft
404 Sleeve
406 Circumferential surface (sleeve)
407 Surface (shaft)
408 Seal gap
414 End face (bearing bush)
415 End face (sleeve)

1. A fluid dynamic bearing system particularly for a spindle motor, having a rotating component comprising a shaft (1; 101; 401) and a hub (3; 103) connected to the shaft, and a stationary component comprising a bearing bush (2; 102; 202) made of a porous material, the shaft being accommodated in the bearing bush and rotatably supported with respect to the bearing bush, and there being a bearing gap (5; 105) filled with a bearing fluid between the shaft and the bearing bush, characterized in that the bearing bush (2; 102; 202) is at least partly enclosed by a sleeve (4; 104; 204; 304; 404), and that a surface (6; 106; 206; 306; 415) of the sleeve (4; 104; 204; 304; 404) together with an adjoining surface (7; 107; 407) of the rotating component forms a conical seal.

2. A fluid dynamic bearing system according to claim 1, characterized in that a circumferential surface (6; 106; 206; 306) of the sleeve (4; 104; 204; 304) together with an adjoining surface (7; 107) disposed on an inside circumference of the hub (3; 103; 203) forms the conical seal.

3. A fluid dynamic bearing system according to claim 1, characterized in that an end face (415) of the sleeve (404) and an end face (414) of the bearing bush (102) together with an adjoining surface (407) disposed on the shaft (401) forms the conical seal.

4. A fluid dynamic bearing system according to claim 1, characterized in that the conical seal comprises a seal gap (8; 108; 408) connected to the bearing gap (5; 105), the seal gap being partly filled with bearing fluid and narrowing in the direction of the bearing gap.

5. A fluid dynamic bearing system according to claim 4, characterized in that the seal gap (8; 108) extends mainly parallel to the bearing gap (5; 105).

6. A fluid dynamic bearing system according to claim 4, characterized in that the seal gap (408) extends mainly perpendicular to the bearing gap (105).

7. A fluid dynamic bearing system according to claim 1, characterized in that the sleeve (4; 104; 204; 304; 404) has at least one open end having a rim.

8. A fluid dynamic bearing system according to claim 7, characterized in that the sleeve (4; 104; 204; 304) has a first outside diameter that continuously increases in the region of the rim up to a second outside diameter.

9. A fluid dynamic bearing system according to claim 7, characterized in that the sleeve (4; 104; 204; 304; 404) is made of plastics at least in the region of the rim.

10. A fluid dynamic bearing system according to claim 7, characterized in that the sleeve (204; 304) is made of two parts, one part (204a; 304b) forming the rim.

11. A fluid dynamic bearing system according to claim 1, characterized in that the sleeve (4; 104; 204; 304; 404) takes the shape of a can and is closed at one end by a bottom piece.

12. A fluid dynamic bearing system according to claim 1, characterized in that the sleeve (4; 104; 204; 304; 404) is made of plastics.

13. A fluid dynamic bearing system according to claim 1, characterized in that the bearing bush (2; 102; 202) is made of a sintered material.
